(19) United States
(12) Patent Application Publication
(10) Pub. No.: US 2012/0210769 A1
(43) Pub. Date: Aug. 23, 2012

(54) APPARATUS AND METHODS FOR FLUID CONTAMINATION DETECTION SYSTEM

(75) Inventor: John Roper, Bonner Springs, KS (US)

(73) Assignee: AEROSOFT, LLC, Bonner Springs, KS (US)

(21) Appl. No.: 13/400,452

(22) Filed: Feb. 20, 2012

Related U.S. Application Data
(60) Provisional application No. 61/463,763, filed on Feb. 23, 2011.

(51) Int. Cl. G01M 15/04

(52) U.S. Cl. 73/23.31

(57) ABSTRACT

An apparatus and method for supporting a contamination detection system for determining the presence and levels of foreign particles and/or water in fluid samples, such as fuel. The apparatus may include a contamination detection system, a hollow rod, and a bypass tube. The contamination detection system may have a flush mode in which the fluid bypasses a detection monitor of the contamination detection system, flowing into the hollow rod. The contamination detection system may also have a test mode in which the fluid passes through the detection monitor, through the bypass tube and then into the hollow rod. The hollow rod may be mounted to a collection container for receiving fluid from the hollow rod. A ground wire for eliminating static build up during contamination testing may be conductively coupled with the hollow rod and may be supported on a ground wire support structure fixed to the collection container.

### RELATED APPLICATIONS

This non-provisional patent application claims priority benefit to earlier-filed U.S. provisional patent application titled “Apparatus and Methods for Fluid Contamination Detection System” Ser. No. 61/463,763, filed Feb. 23, 2011, hereby incorporated in its entirety by reference into the present application.

### BACKGROUND

1. Field

The present invention relates to an apparatus that supports and houses a system for detecting contaminants in fluid samples, such as a fuel sample from fuel used in an internal combustion aircraft engine.

2. Related Art

Fuel used in an internal combustion aircraft engine must be free of contamination, such as foreign particles or water, because the presence of such contaminants may lead to engine failure. For example, the presence of foreign particles in jet fuel can obstruct or block pin points in a fuel cell or internal fuel filters of the engine, and the presence of entrained water in jet fuel can freeze during flight, blocking the fuel inlet tubes or extinguishing the combustion process. Therefore, the fuel for an aircraft engine must be tested for foreign particles and water prior to use of the aircraft.

A variety of contamination detection systems are used in laboratories and in the field to test for the presence and level of contamination in fluid samples. For example, samples of jet fuel can be taken from the fuel tank of an aircraft and tested for foreign particles and water, respectively, by the use of a MINIMONITOR kit by Gammon Technical Products, Inc. These kits may also be used to test fuel being pumped into tanker trucks and other types of vehicles.

The MINIMONITOR kit by Gammon Technical Products, Inc. is a contamination detection system based on a fluid sample passing through a membrane filter, after which the membrane filter is analyzed by comparing the color, hue, chroma and density of the membrane filter to a color chart that is used to determine the concentration of contaminants in the fluid. This method is called Colorimetric Assessment. The two other most common methods of determining the contaminants in fluid samples are the Gravimetric Assessment and Visual Assessment. The Gravimetric Assessment method involves weighing the membrane filter after the fluid is passed through it, to determine the concentration and amount of contaminants in the fluid. The Visual Assessment method involves a skilled operator visually inspecting the membrane filter to determine the type and quantity of contaminants trapped in the membrane filter.

The MINIMONITOR kits by Gammon Technical Products, Inc. are cumbersome, because they must directly attach to a collection point of the fuel sample, such as at the under wing nozzle for an aircraft. A weighted discharge hose descends some distance from the test kit housing to a collection container, such as a five gallon bucket. The MINIMONITOR kit includes a cable extending through the discharge hose which may have metal clips attached to either end thereof. For example, a short bonding cable portion extending from one end of the discharge hose is typically clipped to the collection container to reduce static charges that develop during testing. Additionally, a short bonding cable portion extending from another end of the discharge hose can be clipped to the under wing nozzle. These clips are typically small and prone to breakage.

Furthermore, the MINIMONITOR kit by Gammon Technical Products, Inc. does not allow multiple testing of contaminants in one setup, because the assembled housing encasing the membrane filter can only support one testing unit at a time. For aircraft fuel testing of contaminants and water, an operator must climb a ladder multiple times to hook up one test unit, then unhook that test unit and hook up another test unit. Since the assembled housing of the test unit is remote from the collection container, there is typically spillage of fluid sample, such as jet fuel on the ground, during removal of the membrane filter from the assembled housing, which is a safety and an environmental hazard.

Therefore, there is a need for an improved apparatus and method for detecting fluid contamination that does not suffer from the deficiencies of the prior art.

### SUMMARY

Embodiments of the present invention provide a fluid contamination detection support apparatus and method for supporting or encasing contamination detection systems. In some embodiments of the invention, the fluid contamination detection support apparatus may comprise a hollow rod made of electrically-conductive material and configured to fluidly couple with a contamination detection system housing, a grounding cable made of electrically-conductive material having a first end and a second end, a handle configured for supporting the grounding cable thereon, and at least one fastener configured to mount the hollow rod to an inner surface of a collection container. The grounding cable may be conductively coupled with the hollow rod. The fastener may be configured to mount the handle to an outer surface of the collection container.

In another embodiment of the invention, the fluid contamination detection support apparatus may comprise a collection container having an inner surface and an outer surface and a hollow rod made of electrically-conductive material, fixed to the inner surface of the collection container. The hollow rod may be configured to fluidly couple with a contamination detection system housing. The apparatus may further comprise a grounding cable made of electrically-conductive material having a first end and a second end, a handle configured for supporting the grounding cable thereon and fixed to the outer surface of the collection container, and at least one fastener extending through the hollow rod and the collection container. The fastener may mount the hollow rod to the inner surface of the collection container and may mount the handle to the outer surface of the collection container. The grounding cable may be conductively coupled with the hollow rod.

Another embodiment of the present invention discloses a method for testing for contaminants or water in a fuel sample. The method may comprise the steps of passing fuel through a detection monitor of a first contamination detection system, passing fuel flowing out of the first contamination detection system through a bypass tube, and then passing fuel flowing out of the bypass tube through a hollow rod. The first contamination detection system may be fixed relative to the hollow rod. The method may further comprise the steps of collecting fuel flowing out of the hollow rod in a collection container and actuating a valve of the first contamination detection system from a first position to a second position once a pre-determined amount of fuel is in the collection container. When the valve is in the first position, the fuel may pass through the detection monitor and bypass tube. When the valve is in the second position, the fuel may be blocked from flowing into the detection monitor and may flow directly into the hollow rod. The hollow rod may be fixed to the collection container.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### DESCRIPTION OF DRAWING FIGURES

Embodiments of the present invention are described in detail below with reference to the attached drawing figures, wherein:

FIG. 1 is an elevational view of a contamination detection system support apparatus, constructed according to an embodiment of the present invention and attached to a fuel nozzle of an aircraft wing;

FIG. 2 is an isometric view of the contamination detection system support apparatus of FIG. 1, including a cutaway view of a hollow rod within the contamination detection system support apparatus;

FIG. 3 is an exploded view of a contamination detection system of the contamination detection system support apparatus of FIG. 1;

FIG. 4 is an exploded view of a detection monitor of the contamination detection system of FIG. 3;

FIG. 5 is an isometric view of an alternative embodiment of the contamination detection system support apparatus of FIG. 1 with two contamination detection systems and two collection container compartments;

FIG. 6 is a an isometric view of an alternative embodiment of the contamination detection system support apparatus of FIG. 5, with three contamination detection systems, two hollow rods, and three collection container compartments;

FIG. 7 is a flow chart of a method of testing for contaminants in a fluid with one contamination detection system; and

FIG. 8 is a flow chart of a method of testing for contaminants in a fluid with a second contamination detection system fluidly coupled with a first contamination detection system.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

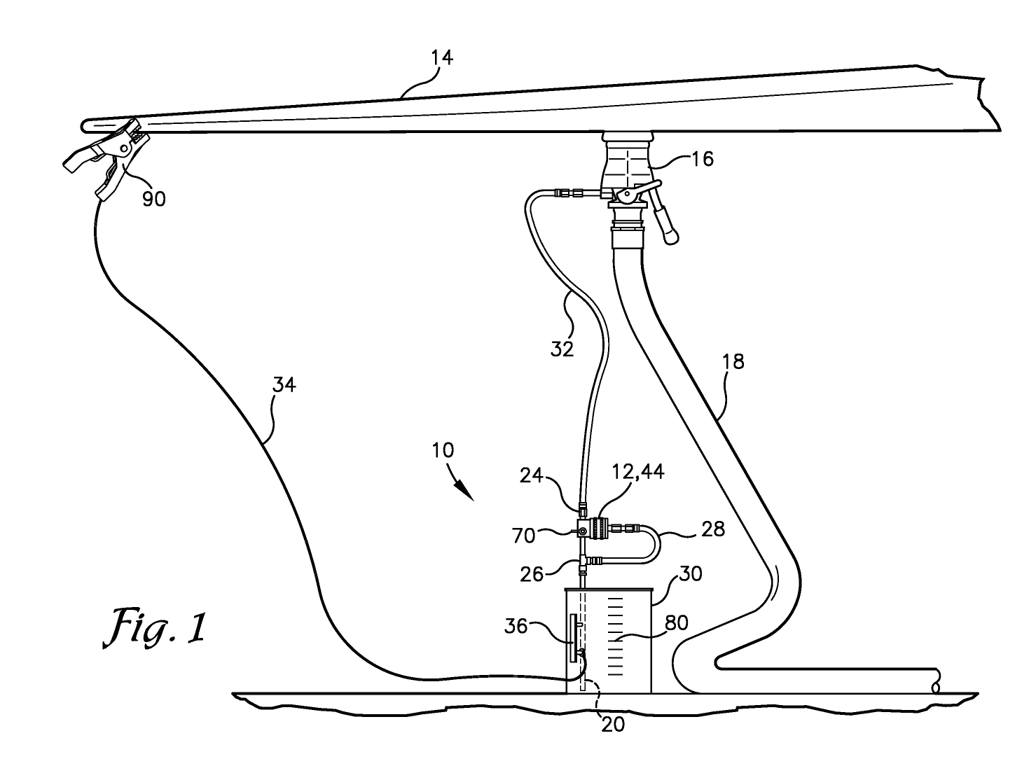

Embodiments of the present invention provide a contamination detection system support apparatus 10, as illustrated in FIG. 1, which is configured for supporting or encasing at least one contamination detection system 12 for determining the presence and levels of foreign particles and/or water in fuel or other fluid samples. For example, as illustrated in FIG. 1, a fuel sample may be taken from a fuel system used in an internal combustion aircraft engine. FIG. 1 illustrates an aircraft wing 14 with a fuel nozzle 16 extending therefrom and a fuel hose 18 fluidly coupled to the fuel nozzle 16. As fuel is pumped through the aircraft nozzle 16, a sample of the fuel may be fed to the support apparatus 10 and/or the contamination detection system 12, as later described herein. A test pad in the contamination detection system 12 may later be removed therefrom and analyzed for contaminants using various known methods, such as visual inspection, colormetric inspection, gravimetric inspection, etc.

The support apparatus 10 may comprise the contamination detection system 12, a hollow rod 20, mounting brackets 22, fluid connectors 24,26, and a bypass tube 28. Alternatively, the support apparatus 10 may not comprise the contamination detection system 12, but may be configured to be attached to and used with the contamination detection system 12. Furthermore, in some embodiments of the invention, the support apparatus 10 may comprise a collection container 30, a fluid delivery hose 32, a ground wire 34, and a ground wire support structure 36 fixed to the collection container 30 and the hollow rod 20.

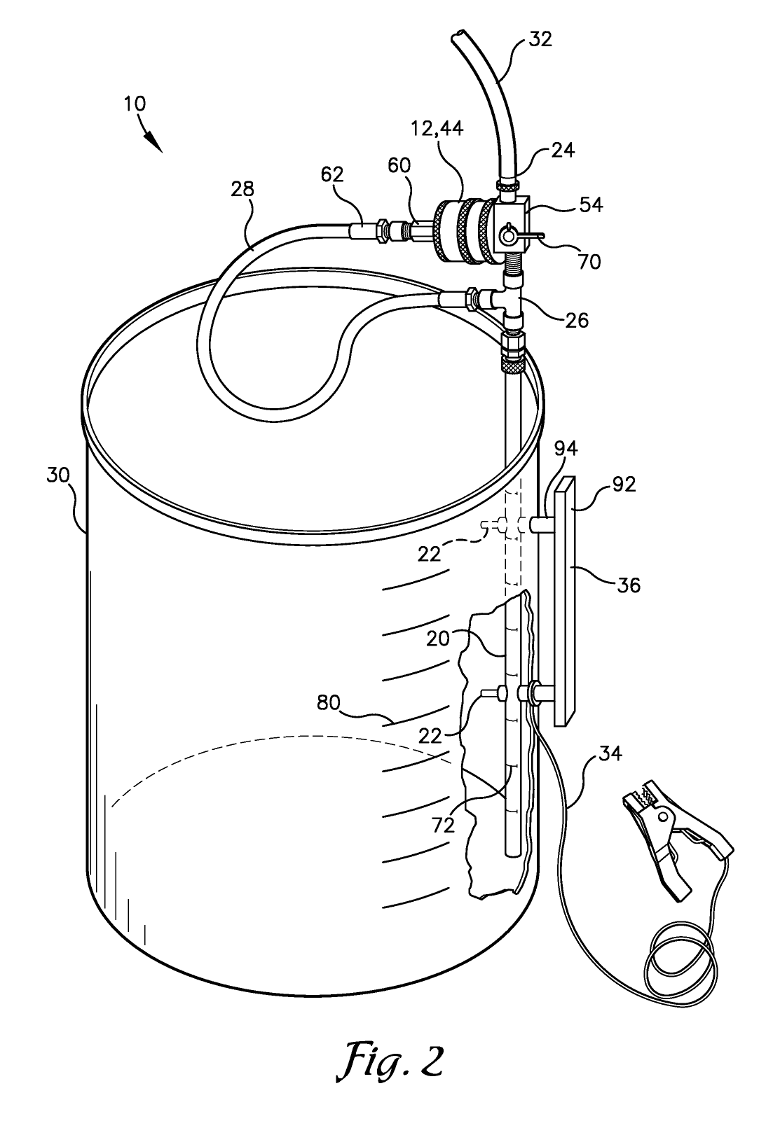

As illustrated in FIGS. 2-4, the contamination detection system 12 may comprise any particle or water-detection systems for fuel or any other known device for detecting contamination in a fluid sample. For example, the contamination detection system 12 may include the MINIMONITOR kit and/or the AQUA GLO water detector, both manufactured by Gammon Technical Products, Inc. Any other types of water and contamination-detection systems may be used, such as a SHELL Water Detector or other such fuel testing units, without departing from the scope of the invention. In some embodiments of the invention, the contamination detection system 12 may comprise a detection monitor 38 comprising a test pad 40 and a test pad holder 42 and a detection system housing 44.

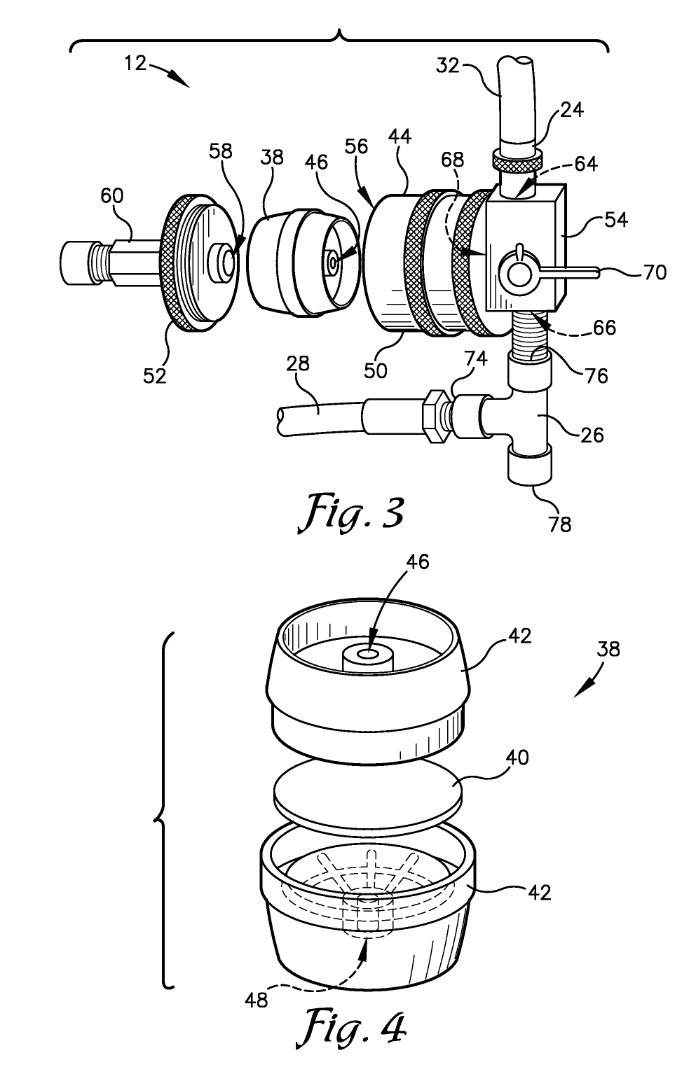

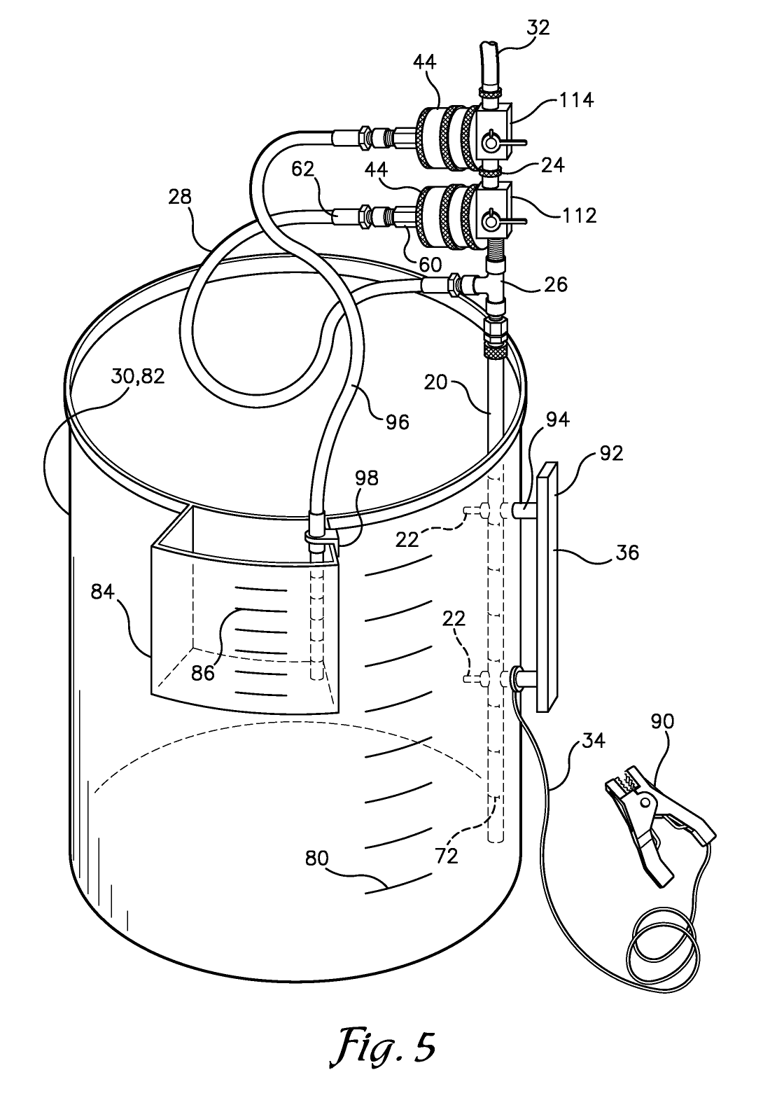

The detection monitor 38, as illustrated in FIGS. 3 and 4, may be the plastic monitor of the MINIMONITOR kit by Gammon Technical Products, Inc. The test pad 40 may be a paper pad with various filtering properties. For example, in a detection monitor configured to test water content of fuel, the paper pad may be treated with sodium fluorescein on one side thereof. The test pad holder 42 may be a plastic housing having two hollow halves which may screw together to secure the test pad 40 therebetween. As illustrated in FIG. 4, the test pad holder 42 may have an inlet hole 46 and an outlet hole 48 formed therein and configured to allow fluid to pass through the test pad holder 42 and through the test pad 40.

The detection system housing 44 may be configured to detachably attach to one of the fluid connectors 24,26, the bypass tube 28, and/or the fluid delivery hose 32. Alternatively, parts of the detection system housing 44 may be integrally formed (i.e., single-piece construction) with at least one of the fluid connectors 24,26, the hollow rod 20, and/or the bypass tube 28. In some embodiments of the invention, the support apparatus 10 may comprise the detection system housing 44, but may not include the test pad 40 and/or the test pad holder 42, which may be purchased or manufactured separately.

The detection system housing 44 may comprise a monitor holder 50, a holder cap 52, and a three-way valve 54. The monitor holder 50 may be a container sized and configured to house the detection monitor 38 and/or components thereof. For example, the monitor holder 50 may be configured to house the test pad 40 (e.g., filter) and the test pad holder 42 (e.g., plastic monitor), such as those included in the plastic monitor of the MINIMONITOR kit by Gammon Technical Products, Inc. The monitor holder 50 may have a first opening 56 formed therein through which the test pad and the test pad holder may be inserted and a second opening (not shown) opposite of the first opening and fluidly coupled with the three-way valve 54. The second opening of the monitor holder 50 may be configured to substantially align with the inlet hole 46 of the test pad holder 42 placed into the monitor holder 50.

The first opening 56 formed in the monitor holder 50 may be covered with the holder cap 52, configured to attach to the monitor holder 50. For example, the holder cap 52 may comprise threads configured to mate with threads formed on the monitor holder 50 by rotation of the holder cap 52 and/or the monitor holder 50 relative to each other. The holder cap 52 may comprise a hole 58 formed therethrough and configured to be fluidly coupled with the bypass tube. For example, a quick disconnect fluid coupler 60 may be aligned with the hole 58 and fixed to the holder cap 52, and may be configured to fluidly couple with a quick disconnect valve 62 at one end of the bypass tube 28. The outlet hole 48 of the test pad holder 42 may be aligned with the hole 58 formed through the holder cap 52.

As depicted in FIG. 3, the three-way valve 54 may comprise one inlet 64 configured to be fluidly coupled with the fluid delivery hose 32, two outlets 66,68, and a switch 70 configured to direct the fluid through at least one of the two outlets 66,68 at a time. The two outlets 66,68 of the three-way valve 54 may comprise a flush outlet 66 fluidly coupled with one of the fluid connectors 24,26 and/or the hollow rod 20 and a test outlet 68 fluidly coupled with the monitor holder 50. The three-way valve 54 may be configured to allow flow through only one of the two outlets 66,68 at a time. For example, the three-way valve 54 may be configured to allow fluid to flow through the test outlet 68 only when in a test mode and through the flush outlet 66 only when in a flush mode. Alternatively, the three-way valve 54 may be configured to allow fluid to flow through both outlets 66,68 simultaneously in a test mode and then allow fluid to flow through the flush outlet 68 only in a flush mode, while blocking flow to the test outlet 66. The switch 70 may be any mechanical and/or electrical device configured to actuate the three-way valve 54 from the test mode to the flush mode and from the flush mode back to the test mode. The switch 70 may be manually operated by a user of the support apparatus 10 and/or automatically switched via some automated or electrical control device.

The hollow rod 20 may be integral or of one-piece construction with the mounting brackets 22 and/or the fluid connectors 24,26, or separately attached thereto. The hollow rod 20 may be made of a metal, plastic, or other suitable materials. In some embodiments of the invention, the hollow rod 20 may be machined from a single piece of material such as stainless steel or copper-free aluminum in the form of tubing, sheet, or plate metal. The size and length of the hollow rod 20 may be determined by the desired size of the collection container 30 and/or a desired flow rate therethrough. The hollow rod 20 may have measurement lines 72 scribed thereon perpendicular to the axial length of the hollow rod 20 and used to accurately measure a volume of fluid in the collection container 30. Furthermore, the hollow rod 20 may have holes and/or threaded holes formed therein for receiving the mounting brackets 22 and/or may comprise brackets or protrusions on an exterior surface thereof configured for facilitating attachment to the collection container 30.

The mounting brackets 22 may be any attachment brackets, fasteners, or fittings and may be integrally formed with the hollow rod 20, as noted above, or separately attached thereto. For example, the mounting brackets 22 may include a nut, spacers, and/or a bolt extending through the hollow rod 20 and/or the collection container 30, as illustrated in FIG. 2. The mounting brackets may be made of any substantially rigid and durable materials, such as plastic or metal. In some embodiments of the invention, the mounting brackets may be made of an electrically conductive material, such as metal. The mounting brackets 22 may be configured to fix the hollow rod 20 within the collection container 12, proximate to an interior surface of the collection container 30. The mounting brackets 22 may also be configured to support the contamination detection system 12 and/or the detection system housing 44 thereon, such as by way of one of the fluid connectors 24,26.

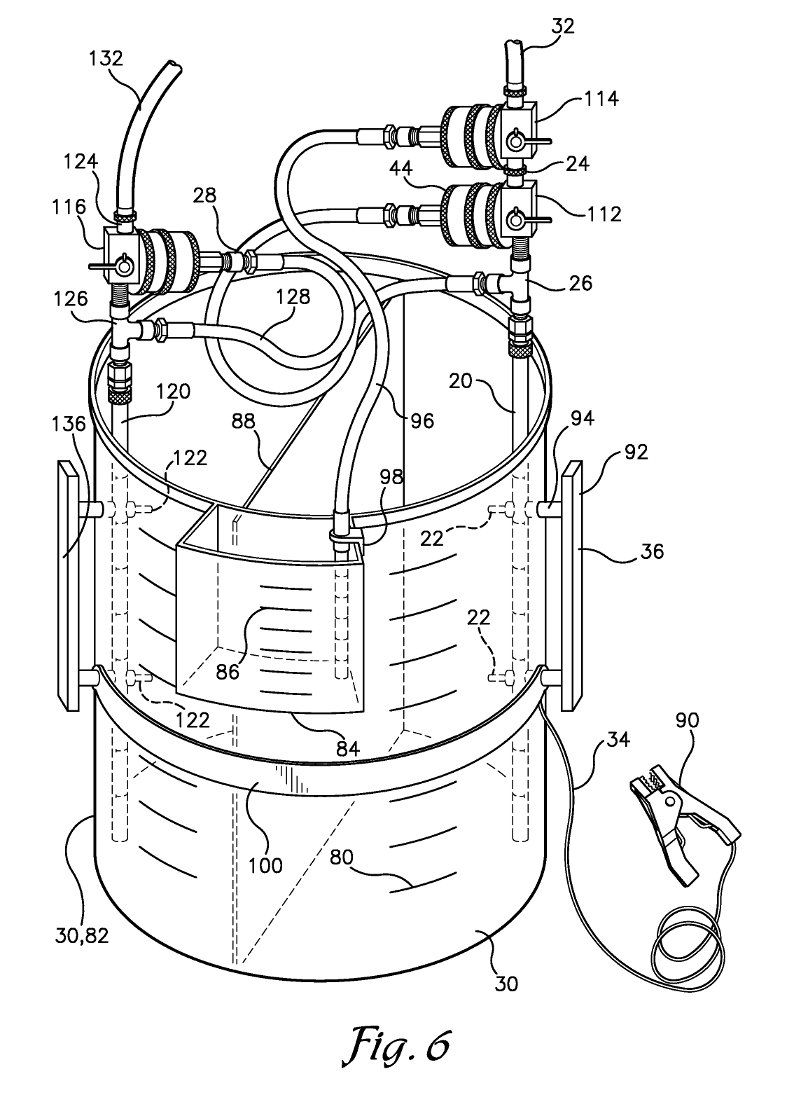

The fluid connectors 24,26 may be any conduits configured to allow fluid to pass therethrough and to fixedly connect one fluid conduit to another fluid conduit. In some embodiments of the invention, some or all of the fluid connectors 24,26 may be integrally formed with the hollow rod 20 and/or the detection system housing 44. The fluid connectors 24,26 may comprise a first fluid connector 24 and/or a second fluid connector 26. The first fluid connector 24 may be configured to connect the contamination detection system 12 (e.g., via the inlet 64 of the three-way valve 54) with the fluid delivery hose 32. Alternatively, the first fluid connector 24 may be omitted or the first fluid connector 24 may be integrally formed with the three-way valve 54 and/or the fluid delivery house 32. In some alternative embodiments of the invention, the first fluid connector 24 may connect two contamination detection systems 12 with each other, as later described herein and illustrated in FIGS. 5 and 6.

The second fluid connector 26 may be configured to connect the contamination detection system 12 to the hollow rod 20 and/or the bypass tube 28. For example, in some embodiments of the invention, the second fluid connector 26 may have three openings, including a first inlet 74, a second inlet 76, and an outlet 78, as illustrated in FIG. 3. The outlet 78 of the second fluid connector 26 may be attached to and fluidly coupled with the hollow rod 20. The first inlet 74 of the second fluid connector 26 may be configured to attach to and be fluidly coupled with the contamination detection system 12 (e.g., via the hole 58 in the holder cap 52 and the bypass tube 28). The second inlet 76 of the second fluid connector 26 may be configured to attach to and be fluidly coupled with the flush outlet 66. As illustrated in FIG. 3, the second fluid connector 26 may be a substantially T-shaped or Y-shaped tube located between the hollow rod 20, the bypass tube 28, and the contamination detection system 12, with an inner surface of the second fluid connector 26 having screw threads or other attachment features protruding therefrom or formed therein.

The bypass tube 28 may be any hollow tube, rigid or flexible, having a first opening at a first end and a second opening at a second end thereof. The bypass tube 28 may be configured to attach to and fluidly couple with the contamination detection system 12 and/or the detection system housing 44 at the first end and may be configured to attach to and fluidly couple with one of the fluid connectors 24,26 and/or the hollow rod 20 at the second end. Fluid flows through the bypass tube 28 when the contamination detection system 12 and/or the detection system housing 44 is placed into the test mode, such as by actuation of the switch 70. Conversely, while the contamination detection system 12 and/or the detection system housing 44 is placed into the flush mode, the fluid is not directed through the bypass tube 28.

The collection container 30 may be any container with at least one opening at or proximate to a top thereof. For example, the collection container 30 may be a pre-manufactured standard plastic five gallon bucket or may be constructed from materials such as steel, aluminum or plastic. In some embodiments of the invention, the interior surface of the collection container 30 may comprise fasteners, brackets, spacers, and/or pads configured to support attachment of the hollow rod 20, the mounting brackets 22, and/or the detection system housing 44 to its interior surface. Furthermore, the ground wire support structure 36 may be fixed to the collection container 30 at an outer surface of the collection container 30, as illustrated in FIG. 2. The collection container 30 may also have measurement lines 80 scribed thereon perpendicular to the axial length or height of the collection container 30 and used to accurately measure a volume of fluid in the collection container 30.

In some embodiments of the invention, the collection container 30 may contain multiple compartments for holding different fluid samples. For example, the collection container 30 may comprise a first collection compartment 82 and a second collection compartment 84, which may also be constructed from materials such material as steel, aluminum or plastic. In some embodiments of the invention, as illustrated in FIG. 5, the second collection compartment 84 may be separately formed from the collection container 30 and configured to attach to the interior surface or exterior surface of the collection container 30 by means of attachment methods described herein, such as the mounting brackets used for attaching the hollow rod 20 to the collection container 30. The second collection compartment 84 may have a separate set of measurement lines 86 scribed thereon or may display other volume-determining indicators. However, the collection container 30 may be divided into any plurality of containers depending on the number of simultaneous tests being conducted thereon, as described below. For example, as illustrated in FIG. 6, the collection container 30 may comprise the collection container's first collection compartment 82 divided into two separate compartments by a divider 88 formed down the middle thereof and may have the second collection compartment 84 attached to an outer surface of the first collection compartment 82.

The fluid delivery hose 32 may be any conventional hose, tube, or piping configured to transport fluid therethrough. For example, the fluid delivery hose 32 may be the bounding and grounding hose assembly of the MINIMONITOR kit by Gammon Technical Products, Inc. The fluid delivery hose 32 may be configured to fluidly couple with a fluid source, such as at the aircraft nozzle 16 during fueling of the aircraft. The fluid delivery hose 32 may also be configured to fluidly couple with the inlet 64 of the three-way valve 54 of the detection system housing 44. The fluid delivery hose 32 may comprise fluid connector components at each end thereof comprised of metal or other conductive materials and configured to align with and fix the fluid delivery hose 32 to the fluid source and/or the three-way valve 54 of the detection system housing 44. The fluid delivery hose 32 may have a wire (not shown) extending therethrough and connected at each end to the fluid connector components of the fluid delivery hose 32. This conductive path between the fluid source and the three-way valve 54 is formed to counter static build up from fuel flowing therethrough, in conjunction with the ground wire 34 described below.

The ground wire 34 may be a bonding cable or other such conductive wires or cables and may have a conductive clip 90 and/or an electrical plug or pin at one end thereof and maybe conductively coupled with the hollow rod 20. For example, the ground wire 34 may be fixed to a conductive element of the ground wire support structure 36, which may contact the conductive hollow rod 20. The conductive clip 90 and/or electrical plug or pin may be attached to or physically make contact with the aircraft, the aircraft nozzle 16, or other such aircraft components. Alternatively, the conductive clip 90 and/or the ground wire 34 may be placed in contact with any grounding structure, such as a metal rod partially buried in nearby ground. The connection of the ground wire 34 between the aircraft and the hollow rod 20 may be configured to counter static build up from fuel flowing through the fluid delivery hose 32 and/or the hollow rod 20. The ground wire 34 may be used to eliminate static build up during contamination testing.

The ground wire support structure 36 may include a handle 92 and/or a plurality of spacers 94. The handle 92 may at least partially be formed of a conductive material and the ground wire 34 may be connected thereto. In some embodiments of the invention, the mounting brackets 22 described above are bolts or other metal fittings extending through the hollow rod 20, through the collection container 30, through one or more spacers 94, and through or into the handle 92, thereby electrically connecting the handle 92 and the ground wire 34 with the hollow rod 20 for countering static build-up, as noted above. The spacers 94 may be implement on the outer and/or interior surface of the collection container 30 and may provide a structure outward of the collection container 30 onto which the ground wire 34 may be wound or wrapped around for storage purposes. The spacers 94 may also maintain the hollow rod 20 a space away from an inner surface of the collection container 30. In some embodiments of the invention, the spacers 94 may be omitted or integrally formed with the handle 92 (i.e., the spacers and handle may be formed of one-piece construction).

In some alternative embodiments of the invention, the apparatus 10 may comprise more than one contamination detection system 12, each having the contamination detection system components described above. For example, as illustrated in FIG. 5, a first contamination detection system 112 may be fluidly coupled with a second contamination detection system 114. For example, the first contamination detection system 112 may be configured to detect an amount of particulate in the fluid while the second contamination detection system 114 may be configured to detect water content in a fluid such as fuel. The inlet 64 of the three-way valve 54 of the first contamination detection system 112 may be fluidly coupled with an outlet of the second contamination detection system 114, such as the flush outlet 66 of the second contamination detection system 114. For example, the inlet 65 of the three-way valve 54 of the first contamination detection system 112 may be fluidly coupled with the flush outlet 66 of the second contamination detection system 114 via the first fluid connector 24.

In some embodiments of the invention, as illustrated in FIG. 5, the three-way valve 54 of the first contamination detection system 112 may be configured to only allow fluid to flow through one of its outlets 66,68 at once, but the three-way valve 54 of the second contamination detection system 114 may be configured to allow fluid to flow through both of the outlets 66,68 of the second contamination detection system 114 simultaneously. This allows the first and second contamination detection systems 112,114 to run simultaneously, since fluid still flows to the inlet 64 of the first contamination detection system 112 while the second contamination detection system 114 is in test mode.

In this alternative embodiment of the invention, as illustrated in FIG. 5, the first contamination detection system 112 may be coupled to the bypass tube 28, the second fluid connector 26, and the hollow rod 20, as described above. However, the second contamination detection system 114 may be fluidly coupled with a secondary tube 96 in stead of the bypass tube 28. Specifically, the secondary tube 96 may fluidly connect with the hole 58 of the holder cap 52 of the second contamination detection system 114. The secondary tube 96 may be configured to direct fluid passed therethrough into the second collection compartment 84 of the collection container 30 described above. The secondary tube 96 may be a rigid or flexible tube similar in construction to the bypass tube 28. However, the secondary tube 96 may be any conduit configured to allow fluid to pass therethrough from the second contamination detection system 114 to the second collection compartment 84 of the collection container 30. The secondary tube 96 may be fixed to the second collection compartment 84 via a clip 98 or any other attachment means. As noted above, the second collection compartment 84 may have measurement indications 86 thereon so that an operator can determine how much fluid has passed through the second contamination detection system 114.

In another alternative embodiment of the invention, as illustrated in FIG. 6, the apparatus 10 may further include a third or supplemental contamination detection system 116 fluidly coupled with a supplemental hollow rod 120, which may be mounted to the collection container 30 with supplemental mounting brackets 122. The supplemental contamination detection system 116 and each of the components attached thereto may be substantially identical to the contamination detection system 12 or the first contamination detection system 112 and each of the components attached thereto. Specifically, the supplemental contamination detection system 116 may be fluidly coupled with the supplemental hollow rod 120 via supplemental fluid connectors 124,126 and a supplemental bypass tube 128. Furthermore, fluid or fuel may be fed to the supplemental contamination detection system 116 with a supplemental fluid delivery hose 132. A supplemental ground wire (not shown) and a supplemental ground wire support structure 136 may also be fixed to the collection container 30 and the supplemental hollow rod 120. However, as illustrated in FIG. 6, the supplemental ground wire may be omitted and a conductive link 100 may conductively connect the hollow rod 20 and the supplemental hollow rod 120. For example, the conductive link 100 may be a metal strip may extend between the mounting brackets 22 and the supplemental mounting brackets 122 and/or between the ground wire support structure 36 and the supplemental ground wire support structure 136.

In some embodiments of the invention, a portion of the liquid to be tested may flow through the hollow rod 20 into a first half of the first collection compartment 82 of the collection container 30 while another portion of the liquid may flow through the supplemental hollow rod 120 into a second half of the first collection compartment 82. Yet another portion of the liquid may pass through the secondary tube 96 to the second collection compartment 84. However, in some embodiments of the invention, the second contamination detection system 114 and the second collection compartment 84 may be omitted from the apparatus illustrated in FIG. 6. In other embodiments of the invention, the first, second and third or supplemental contamination detection systems 112,114,116 may be part of a single apparatus and may operate substantially simultaneously in test and/or flush mode, as illustrated in FIG. 6.

In use, fluid to be tested by the apparatus 10 may flow from the fluid deliver hose 32 into the inlet 64 of the three-way valve 54 of the contamination detection system 12. Additionally or alternatively, fluid may flow from the flush outlet 66 of the second contamination detection system 114 into the inlet 65 of the three-way valve 54 of the first contamination detection system 112. When the three-way valve 54 of the contamination detection system 12 is actuated to the flush mode, the fluid may flow out through the flush outlet 66 into the second fluid connector 26 and then through the hollow rod 20. When the three-way valve is actuated to the test mode, fluid may additionally or alternatively flow through the test outlet 68 into the monitor holder 50, through the detection monitor 38, through the hole 58 of the holder cap 52, and into the bypass tube 28. From the bypass tube 28, the fluid may then flow into the second fluid connector 26 and then through the hollow rod 20 into the collection container 30.

In alternative embodiments of the invention, fluid may pass from the hole 58 of the holder cap 52 of the second contamination detection system 114 into the secondary tube 96 and then into the second collection compartment 84. After a predetermined amount of fuel is passed through the test pads 40 using the methods described herein, a variety of fuel or fluid testing may be conducted by analyzing the test pads 40 of the contamination detection systems 12,112,114,116. For example, the first contamination detection system 112 may receive a fluid sample before it enters a fuel system's filter and the supplemental contamination detection system 116 may receive a fluid sample after it flows through the fuel system's filter, so that the effectiveness of the filter may be tested by comparing the test pad 40 of the first contamination detection system 112 with the test pad 40 of the supplemental contamination detection system 116. Other methods of analyzing test pads to determine amounts and types of contaminants in fuel may be used in conjunction with the methods described herein without departing from the scope of the invention.

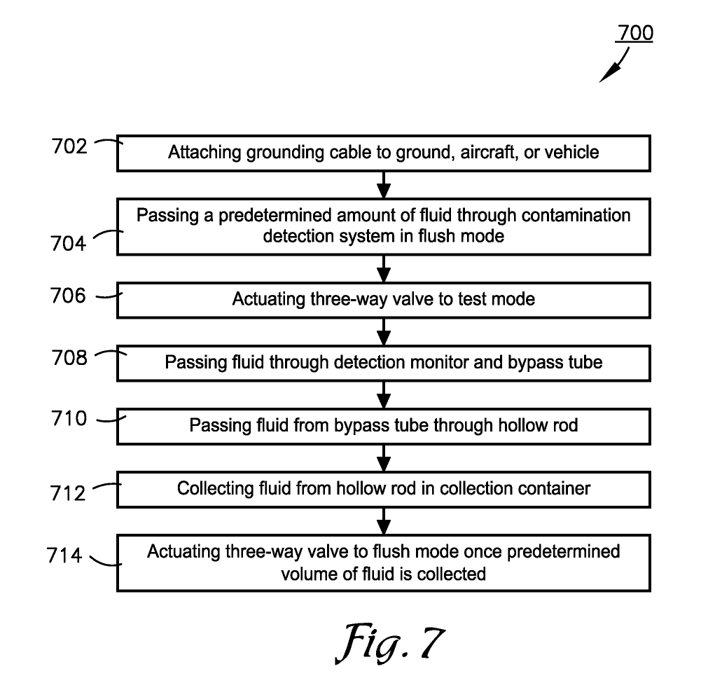

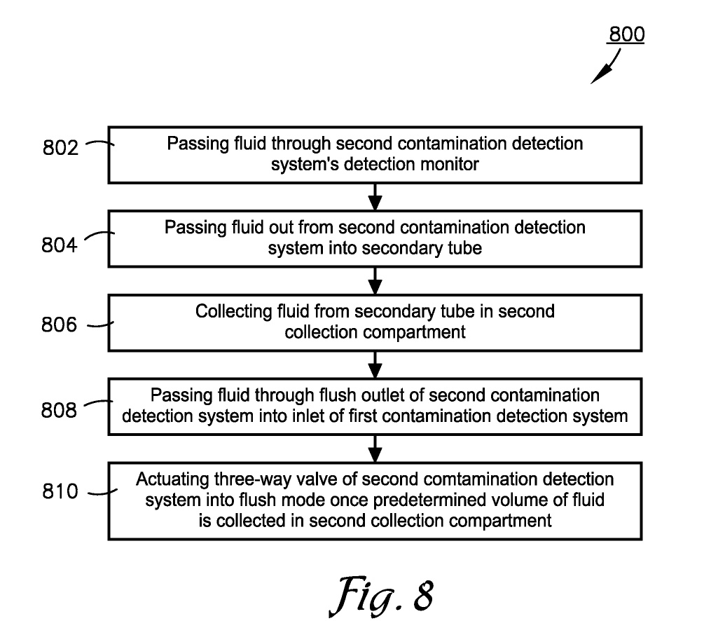

The flow charts of FIGS. 7 and 8 illustrate methods 700 and 800 of testing for contaminants and water in a fluid such as fuel according to various embodiments of the present invention. In some alternative implementations, the functions noted in the various blocks may occur out of the order depicted in FIGS. 7 and 8. For example, two blocks shown in succession in FIGS. 7 and/or 8 may in fact be executed substantially concurrently, or the blocks may sometimes be executed in the reverse order depending upon the functionality involved.

The method 700 may comprise a step of attaching or clipping the ground cable 34 to an electrical ground or to a vehicle from which the collection container 30 is receiving the fluid, as depicted in block 702. Next, the method 700 may comprise a step of passing the fluid to be tested through the three-way valve 54 of the contamination detection system 12 with the three-way valve 54 in flush mode until a predetermined volume of fluid fills the contamination container 30, as depicted in block 704. Then, the method 700 may comprise the step of actuating the three-way valve 54 (e.g., via the switch 70) to the test mode, as depicted in block 706. In test mode, the method 700 may comprise the steps of passing the fluid flowing out of the contamination detection system 12 through the bypass tube 28, as depicted in block 708, and passing the fluid flowing out of the bypass tube 28 through the hollow rod 20, as depicted in block 710. Next, the method 700 may comprise the steps of collecting the fluid flowing out of the hollow rod in the collection container 30, as depicted in block 712, and actuating the switch 70 of the three-way valve 54 from the test mode to the flush mode once a pre-determined amount of the fluid is in the collection container 30, as depicted in block 714. In the test mode, the fluid may pass through the detection monitor 38 and bypass tube 28. In the flush mode, the fluid may be blocked from flowing into the detection monitor 38 and may flow directly into the hollow rod 28 via the second fluid connector 26.

Steps 704 through 714 may also be repeated or conducted substantially simultaneously for the supplemental contamination detection system 116 in embodiments of the invention which include the supplemental contamination detection system 116 and its associated components described above, as illustrated in FIG. 6.

In yet another embodiment of the invention, any combination of the first contamination detection system 112, the supplemental contamination detection system 116, and the second contamination detection system 114 may be operated substantially simultaneously. Specifically, the method 800, as illustrated in FIG. 8, may be conducted simultaneously while any or all of the steps of the method 700 are conducted using the first contamination detection system 112 and the supplemental contamination detection system 116. The method 800 may comprise the steps of passing the fluid through the detection monitor 38 of the second contamination detection system 114, as depicted in block 802, and passing the fluid flowing out of the hole 58 in the holder cap 52 of the second contamination detection system 114 through the secondary tube 96, as depicted in block 804.

The method 800 may also comprise the steps of collecting the fluid flowing out of the secondary tube 96 in the secondary collection compartment 84 of the collection container 30, as depicted in block 806, and simultaneously passing fluid flowing through the flush outlet 66 of the second contamination detection system 114 through the inlet 64 of the three-way valve 54 of the first contamination detection system 112, as depicted in block 808. The method 800 may also comprise the step of actuating the three-way valve 54 of the second contamination detection system 114 from the test mode to the flush mode once a pre-determined amount of the fluid is collected in the secondary collection compartment 84, as depicted in block 810. In the test mode, the fluid may flow through both the flush outlet 66 and the test outlet 68 of the three-way valve 54 of the second contamination detection system 114. In the flush mode, the fluid may be blocked from flowing through the detection monitor 38 of the second contamination detection system 114 and may flow only through the flush outlet 66 of the second contamination detection system 114.

The unique configuration of the present invention allows a contaminant testing operator to perform efficient multiple contaminants testing simultaneously with one set-up. Compared to the prior art, the present invention provides an improved, less expensive, compact apparatus that supports typical contamination detection systems. Furthermore, the configuration of the present invention effectively eliminates spillage (spillage from the bypass tube would land in collection container) and eliminates static charge buildup during contaminant testing. The present invention also allows facilitates easy transport and storage, since it attaches to the collection container, allowing the contamination detection system, the apparatus 10 and the collection container to become one unit. Another advantage of the present invention is that a trained technician can easily remove the testing filter from the contamination detection system without supporting the system by means of a second trained technician, support tool, or fixture. The configuration of the apparatus 10 also eliminates the use of redundant pads and filters during testing.

Although the invention has been described with reference to the embodiments illustrated in the attached drawing figures, it is noted that equivalents may be employed and substitutions made herein without departing from the scope of the invention as recited in the claims. For example, though FIG. 1 illustrates a fuel sample being obtained from an aircraft under-wing nozzle, other sources of fuel may be tested at various points in a fuel system. In one alternative embodiment of the invention, one fuel sample may be tested via the first contamination detection system 112 at a fuel filter inlet before fuel passes through a fuel filter therein and another fuel sample may be tested via the supplemental contamination detection system 116 at a fuel filter outlet after fuel passes through the fuel filter. Then test pads from the first and supplemental contamination detection systems 112,116 may be compared with each other to determine the effectiveness of the fuel filter.

Having thus described various embodiments of the invention, what is claimed as new and desired to be protected by Letters Patent includes the following:

1. A fluid contamination detection support apparatus comprising:
a hollow rod made of electrically-conductive material and configured to fluidly couple with a contamination detection system housing;
a grounding cable made of electrically-conductive material having a first end and a second end, wherein the grounding cable is conductively coupled with the hollow rod;
a handle configured for supporting the grounding cable thereon; and
at least one fastener configured to mount the hollow rod to an inner surface of a collection container and to mount the handle to an outer surface of the collection container.

2. The apparatus of claim 1, further comprising a metal clamp fixed to the second end of the ground cable.

3. The apparatus of claim 1, further comprising a hollow fluid connector having two inlets and one outlet, wherein the hollow fluid connector is fixed to or integrally formed of one piece construction with the hollow rod and fluidly coupled with the hollow rod at the outlet of the hollow fluid connector.

4. The apparatus of claim 3, further comprising a bypass tube fixed to and fluidly coupled with one of the inlets of the hollow fluid connector.

5. The apparatus of claim 4, further comprising the contamination detection system housing fixed to the hollow fluid connector and thereby fluidly coupled with the hollow rod.

6. The apparatus of claim 5, wherein the contamination detection system housing comprises a monitor holder sized and configured to house a detection monitor for detecting contaminants in a fluid passed therethrough, a holder cap with a hole formed therethrough fluidly coupled with the bypass tube, and a three-way valve comprising an inlet configured to receiving fluid therethrough, a first outlet fluidly coupled with the monitor holder, and a second outlet fluidly coupled with one of the inlets of the hollow fluid connector.

7. The apparatus of claim 6, further comprising a secondary contamination detection system housing fixed to the contamination detection system housing and fluidly coupled with the inlet of the three-way valve of the contamination detection system housing.

8. The apparatus of claim 1, further comprising the collection container, wherein the handle and the hollow rod are fixed to the collection container with the at least one fastener.

9. The apparatus of claim 8, further comprising a secondary hollow rod fixed within the collection container and conductively coupled with the hollow rod, wherein the secondary hollow rod is configured to fluidly couple with a secondary contamination detection system housing and the collection container is divided into a first portion configured for receiving fluid from the hollow rod and a second portion configured for receiving fluid from the secondary hollow rod.

10. A fluid contamination detection support apparatus comprising:
a collection container having an inner surface and an outer surface;
a hollow rod made of electrically-conductive material, fixed to the inner surface of the collection container, and configured to fluidly couple with a contamination detection system housing;
a grounding cable made of electrically-conductive material having a first end and a second end, wherein the grounding cable is conductively coupled with the hollow rod;
a handle configured for supporting the grounding cable thereon and fixed to the outer surface of the collection container; and
at least one fastener extending through the hollow rod and the collection container and mounting the hollow rod to the inner surface of the collection container and mounting the handle to the outer surface of the collection container.

11. The apparatus of claim 10, further comprising a metal clamp fixed to the second end of the ground cable.

12. The apparatus of claim 10, further comprising a hollow fluid connector having two inlets and one outlet, wherein the hollow fluid connector is fixed to or integrally formed of one piece construction with the hollow rod and fluidly coupled with the hollow rod at the outlet of the hollow fluid connector, and further comprising a bypass tube fixed to and fluidly coupled with one of the inlets of the hollow fluid connector.

13. The apparatus of claim 12, further comprising the contamination detection system housing fixed to the hollow fluid connector and thereby fluidly coupled with the hollow rod.

14. The apparatus of claim 13, wherein the contamination detection system housing comprises a monitor holder sized and configured to house a detection monitor for detecting contaminants in a fluid passed therethrough, a holder cap with a hole formed therethrough fluidly coupled with the bypass tube, and a three-way valve comprising an inlet configured to receiving fluid therethrough, a first outlet fluidly coupled with the monitor holder, and a second outlet fluidly coupled with one of the inlets of the hollow fluid connector.

15. The apparatus of claim 14, further comprising a secondary contamination detection system housing fixed to the contamination detection system housing and fluidly coupled with the inlet of the three-way valve of the contamination detection system housing.

16. The apparatus of claim 10, further comprising a secondary hollow rod fixed within the collection container and conductively coupled with the hollow rod, wherein the secondary hollow rod is configured to fluidly couple with a secondary contamination detection system housing and the collection container is divided into a first portion configured for receiving fluid from the hollow rod and a second portion configured for receiving fluid from the secondary hollow rod.

17. A method of testing for contaminants or water within a fuel sample, the method comprising:
passing fuel through a detection monitor of a first contamination detection system;
passing fuel flowing out of the first contamination detection system through a bypass tube;
passing fuel flowing out of the bypass tube through a hollow rod, wherein the first contamination detection system is fixed relative to the hollow rod;
collecting fuel flowing out of the hollow rod in a collection container, wherein the hollow rod is fixed to the collection container; and
actuating a valve of the first contamination detection system from a first position in which fuel passes through the detection monitor and bypass tube to a second position in which fuel is blocked from flowing into the detection monitor and flows directly into the hollow rod once a pre-determined amount of fuel is in the collection container.

18. The method of claim 17, further comprising:
passing fuel through a detection monitor of a second contamination detection system, wherein the second contamination detection system has a first outlet and a second outlet;
passing fuel flowing out of the first outlet of the second contamination detection system through a secondary tube;
collecting fuel flowing out of the secondary tube in a secondary collection container fixed to the collection container;
passing fuel flowing through the second outlet of the second contamination detection system through an inlet of the first contamination detection system; and
actuating a valve of the second contamination detection system from a first position in which fuel flows through both the first and second outlets to a second position in which fuel is blocked from flowing through the detection monitor of the second contamination detection system and flows only through the second outlet once a pre-determined amount of fuel is collected in the secondary collection container.

19. The method of claim 17, further comprising attaching a ground cable to an electrical ground or to a vehicle from which the collection container is receiving fuel, wherein the ground cable is attached to a handle fixed to an outer surface of the collection container and the ground cable is conductively coupled to the hollow rod, wherein the hollow rod is made of a conductive material.
